(19) United States
(12) Patent Application Publication
(10) Pub. No.: US 2017/0244232 A1
(43) Pub. Date: Aug. 24, 2017

(54) SNAP-IN CABLE CONNECTOR

(71) Applicant: Jinxing Yang, Roland Heights, CA (US)

(72) Inventor: Jinxing Yang, Roland Heights, CA (US)

(21) Appl. No.: 15/441,229

(22) Filed: Feb. 23, 2017

Related U.S. Application Data
(60) Provisional application No. 62/298,565, filed on Feb. 23, 2016.

(51) Int. Cl. H02G 3/22; H02G 15/10

(52) U.S. Cl. CPC H02G 3/22; H02G 15/10

(57) ABSTRACT

A snap fitting has a trailing end adapted to be connected to flexible metallic conduit or metal clad cable, and a cylindrical leading end portion. The leading end portion is uniquely formed with a plurality of locking fingers and tensioning fingers adjacent to and on each side of each locking finger. The locking fingers spread radially axially outwardly from near the outboard end of the leading end portion toward the trailing end. The free ends of the fingers have exterior cam surfaces that engage the edge of the box opening when the fitting is inserted into the opening. This causes the locking fingers to flex radially inwardly during assembly of the fitting to the junction box. The snap fitting can be inserted into both sides of the opening of the junction box.

### CROSS-REFERENCE TO RELATED APPLICATIONS

This application claims priority under 35 U.S.C. §119 (e) to U.S. Provisional Patent Application Ser. No. 62/298,565, filed on Feb. 23, 2016, the entire contents of which are hereby incorporated by reference.

### FIELD OF THE INVENTION

The present invention relates to electrical connectors, and more particularly to a snap-in electrical connector for electrical junction boxes.

### BACKGROUND OF THE INVENTION

In the field of wiring homes and buildings, whether for new construction or for improvements or expansion, substantial development and product improvements have been made. Typically, these improvements are directed to enabling installers to securely mount any desired wiring in any desired location in the most efficient and quickest manner.

In any particular installation or location, various cables must be interconnected to each other as well as connected to the primary power supply in a suitable power distributing junction box or fuse box. In each of these instances, metal sheath cables, within which the electric power carrying wires are contained, must be securely mounted to the housing of the junction box or outlet box, or connected to appropriate devices, in a protected area.

In order to enable installers to securely mount metal sheath cables to any desired junction box or outlet box, numerous prior art connectors have been developed, and recently snap fitting connectors have become popular as a means of connecting cables to electrical junction boxes. As shown in FIG. 1, one such type of snap fitting is disclosed in U.S. Pat. No. 6,709,280 to Gretz (hereinafter the '280 patent), which improved the functionality of the quick connect fitting by providing a snap ring with a grounding tang of a novel design that provided a tighter fit between the quick connect fitting and the junction box or panel that it connected to. The snap fitting of the '280 patent therefore improved the electrical continuity and lowered the millivolt drop between the fitting, the cable, and the junction box.

An improved snap engagement fitting was disclosed in U.S. Pat. No. 6,780,029 (hereinafter the '029 patent) as shown in FIG. 2, which improved the continuity of the snap engagement fitting by providing a snap ring including a locking tang lanced out of the grounding tang. By lancing the locking tang out of the grounding tang, a greater portion of the outer periphery of the snap ring is available for forming the grounding tang. The larger grounding tangs provide more contact between the junction box and the snap ring thereby providing improved electrical continuity and a lower millivolt drop between the fitting, the cable, and the junction box.

Although the snap engagement fittings of the '280 patent and '029 patent vastly improved the electrical continuity of snap engagement fittings constructed of a tubular body and a snap ring, the disclosures required a flange on the tubular body which added to the weight and cost of production of the tubular body. Also, the snap fittings in both '280 and '029 patents can only be inserted into the junction box from one side of the opening, which limits the usage of the snap fitting. Therefore, there remains a need for a new and improved snap fitting to overcome the problems stated above.

### SUMMARY OF THE INVENTION

In one aspect, a snap fitting has a trailing end adapted to be connected to flexible metallic conduit or metal clad cable, and a cylindrical leading end portion. The trailing end can be made to connect various metallic conduit/cable and non-metallic cable in any desired manner. The snap fitting is configured to be assembled to a junction box through an opening in a wall of the junction box.

The leading end portion is uniquely formed with a plurality of locking fingers and tensioning fingers adjacent to and on each side of each locking finger. The locking fingers spread radially axially outwardly from near the outboard end of the leading end portion toward the trailing end. The free ends of the fingers have exterior cam surfaces that engage the edge of the box opening when the fitting is inserted into the opening. This causes the locking fingers to flex radially inwardly during assembly of the fitting to the junction box.

When in use, the snap fitting has a snap-fit with the junction box accomplished simply by pushing the leading edge into an opening of the junction box that causes the fingers to flex inwardly. The assembly of the fitting to the junction box is facilitated by the outer cam surfaces of the fingers. When the biasing unit is adjacent the outer surface of the box wall, the locking fingers are through the opening of the box wall and engage its inner surface to prevent the fitting from being withdrawn. At the same time, the tensioning fingers engage the edge of the opening.

In another aspect, a snap fitting has a trailing end adapted to be connected to flexible metallic conduit or metal clad cable, and a cylindrical leading end portion, The trailing end can be made to connect various metallic conduit/cable and non-metallic cable in any desired manner.

The leading end portion is uniquely formed with two locking fingers spaced 180° apart and tensioning fingers extending from each locking finger. The locking fingers spread radially axially outwardly from near the outboard end of the leading end portion toward the trailing end. Each locking finger has a free end configured to engage the inside surface of the box wall 520 when the fitting has been fully inserted, thereby capturing the box wall between the fingers and the biasing unit, which causes the locking fingers to flex radially inwardly during assembly of the fitting to the junction box. The free ends of the locking fingers are configured to engage the inside surface of the box wall when the fitting has been fully inserted, thereby capturing the box wall between the fingers and the biasing unit. It is important to note that the snap fitting can also be snapped into the box opening from other side of the opening.

### BRIEF DESCRIPTION OF THE DRAWINGS

FIG. 1 illustrates a prior art disclosing a snap ring with a grounding tang that provided a tighter fit between the quick connect fitting and the junction box or panel that it connected to.

FIG. 2 illustrates a prior art disclosing a snap engagement fitting by a snap ring including a locking tang lanced out of the grounding tang.

FIGS. 3 and 3a illustrates a schematic view of the snap fitting in the present invention.

FIGS. 4 and 4a illustrates a schematic view of the snap fitting in another aspect in the present invention.

FIGS. 5, 5a and 5b illustrate schematic view of the snap fitting inserted into the opening of the junction box.

FIGS. 6, 6a and 6b illustrate another embodiment of the snap fitting inserted into the opening of the junction box.

FIGS. 7, 7a and 7b illustrate a further embodiment of the snap fitting inserted into the opening of the junction box.

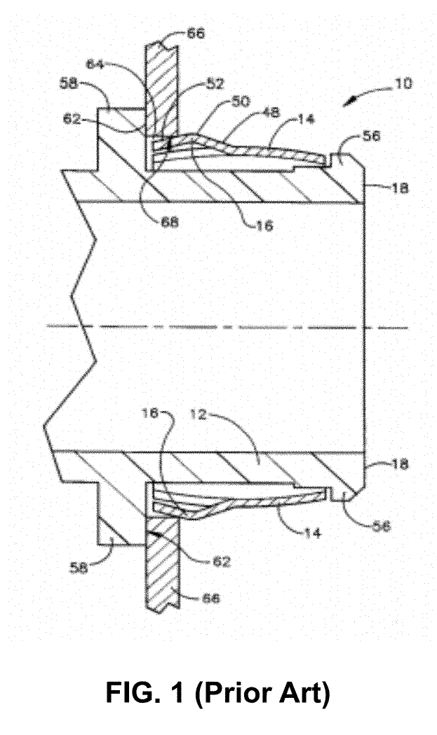

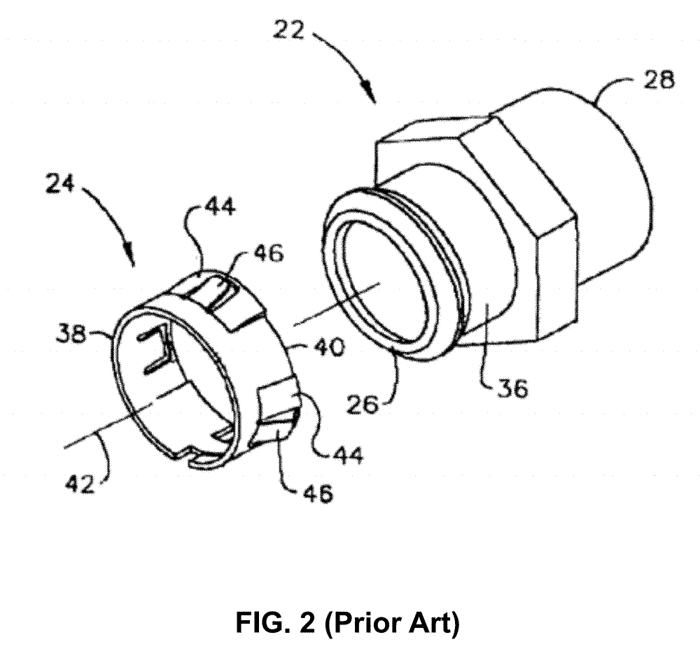

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

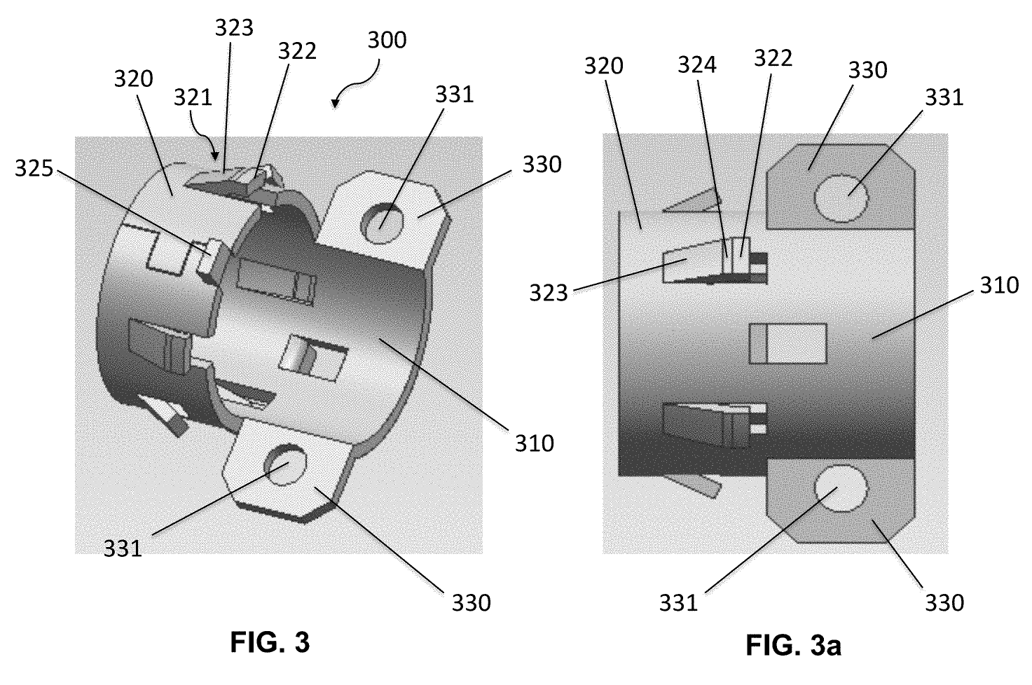

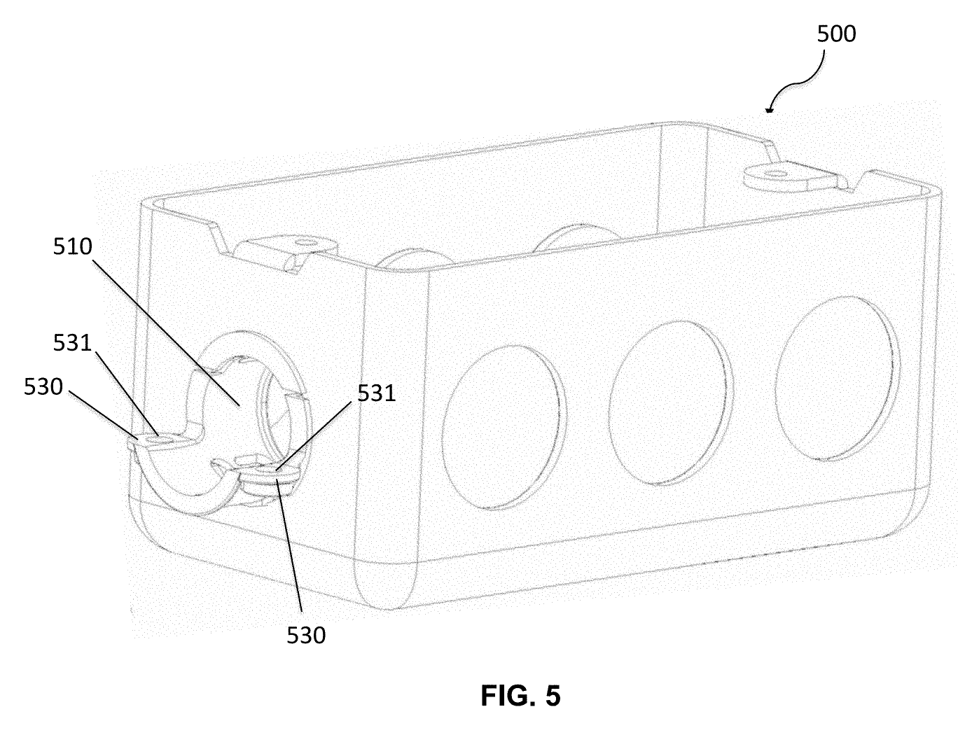

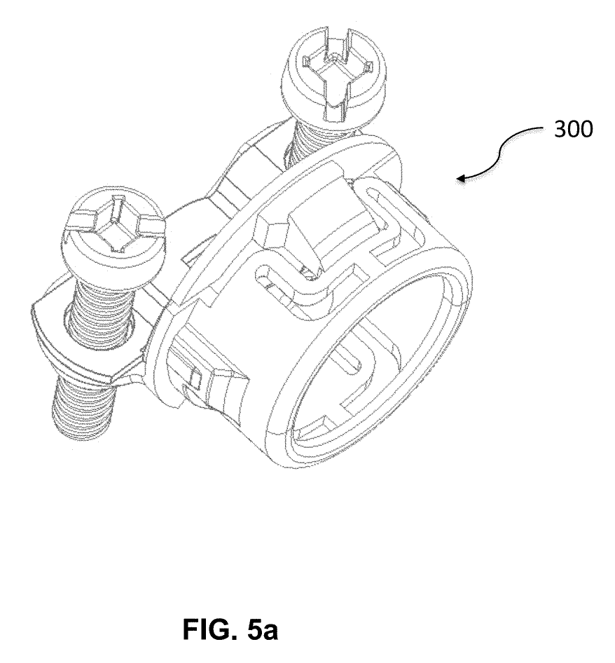

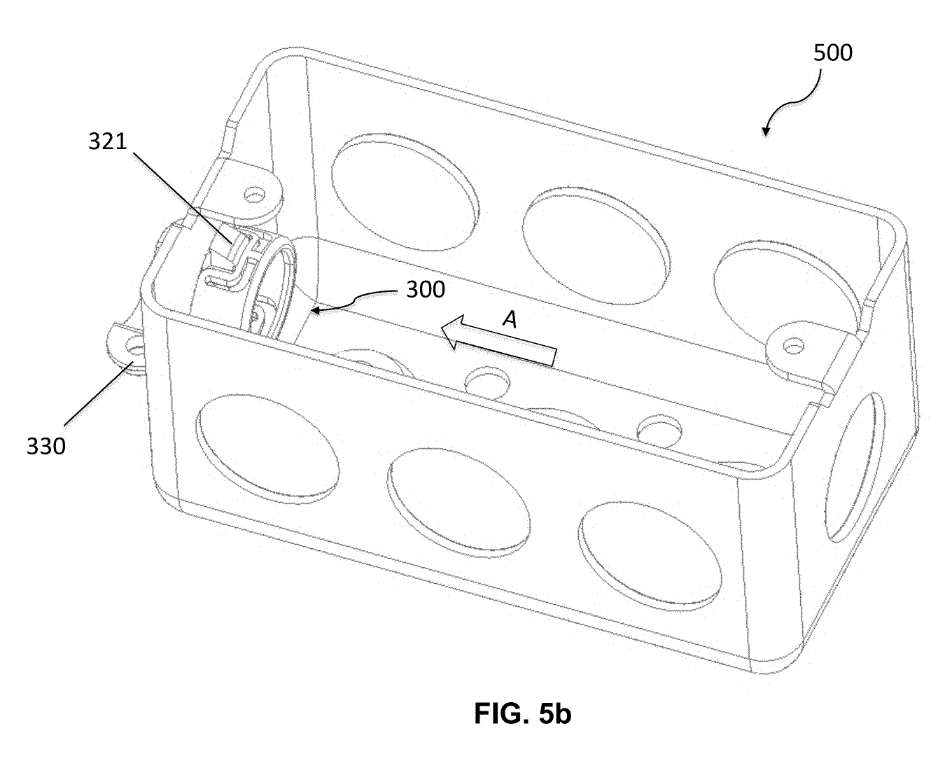

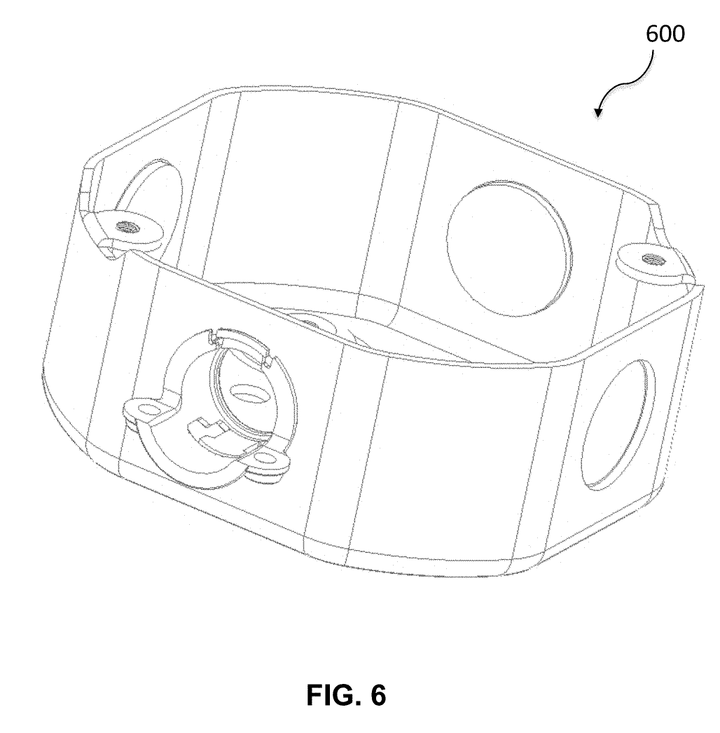

In one aspect, referring to FIG. 3, a snap fitting 300 has a trailing end 310 adapted to be connected to flexible metallic conduit or metal clad cable, and a cylindrical leading end portion 320. The trailing end 310 can be made to connect various metallic conduit/cable and non-metallic cable in any desired manner, The snap fitting 300 is configured to be assembled to a junction box 500 through an opening 510 in a wall 520 of the junction box 500 as shown in FIGS. 5, 5a and 5b.

The leading end portion 320 is uniquely formed with a plurality of locking fingers 321 and tensioning fingers 322 extending from each locking finger 321. The locking fingers 321 spread radially axially outwardly from near the outboard end of the leading end portion 320 toward the trailing end 310. Each locking finger 321 has an exterior slanted surface 323 that facilitates the assembly of the fitting 300 to the junction box 500 when the fitting 300 is inserted into the opening, which enables the locking fingers 321 to flex radially inwardly during assembly of the fitting 300 to the junction box 500. As shown in FIGS. 3, 5, 5a and 5b, each locking finger 320 has a free end 324 configured to engage an inside surface of the box wall 520 when the fitting has been fully inserted, thereby capturing the box wall between the fingers 321 and the biasing unit 325.

When in use, the snap fitting 300 has a snap-fit with the junction box 500 which is accomplished simply by pushing the leading portion 320 into an opening 510 of the junction box 500 which causes the locking fingers 321 and the tension fingers 322 to flex inwardly. The assembly of the fitting 300 to the junction box 500 is facilitated by the outer cam surfaces 323 on the fingers 321. When the biasing unit 325 is adjacent against the outer surface of the box wall 520, the locking fingers 321 are inserted through the opening of the box wall and the free end 324 engages the inner surface of the box wall 520 to prevent the fitting from being withdrawn. At the same time, the tensioning fingers 322 engage the edge of the opening 510. The snap fitting can be further secured on. the junction box by inserting screws into the screw holes 331 and 531.

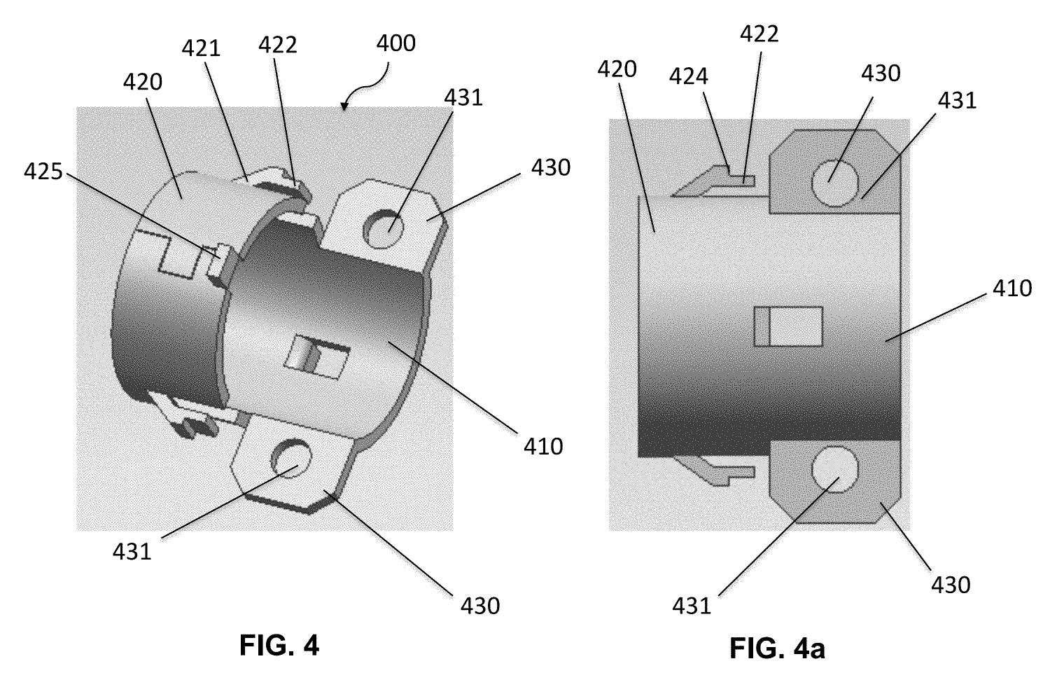

In another aspect, as shown in FIG. 4, a snap fitting 400 has a trailing end 410 adapted to be connected to flexible metallic conduit or metal clad cable, and a cylindrical leading end portion 420. The trailing end 410 can be made to connect various metallic conduit/cable and non-metallic cable in any desired manner.

The leading end portion 420 is uniquely formed with two locking fingers 421 spaced 180° apart and tensioning fingers 422 extending from each locking finger 421. The locking fingers 421 spread radially axially outwardly from near the outboard end of the leading end portion 420 toward the trailing end 410. Each locking finger 421 has a free end 424 configured to engage the inside surface of the box wall 520 when the fitting has been fully inserted, thereby capturing the box wall between the fingers 421 and the biasing unit 425, which causes the locking fingers 421 to flex radially inwardly during assembly of the fitting 400 to the junction box 500. As shown in FIGS. 4, 5, 5a and 5b, the free ends 423 of the locking fingers 420 are configured to engage the inside surface of the box wall 520 when the fitting has been fully inserted, thereby capturing the box wall between the fingers 421 and the biasing unit 425.

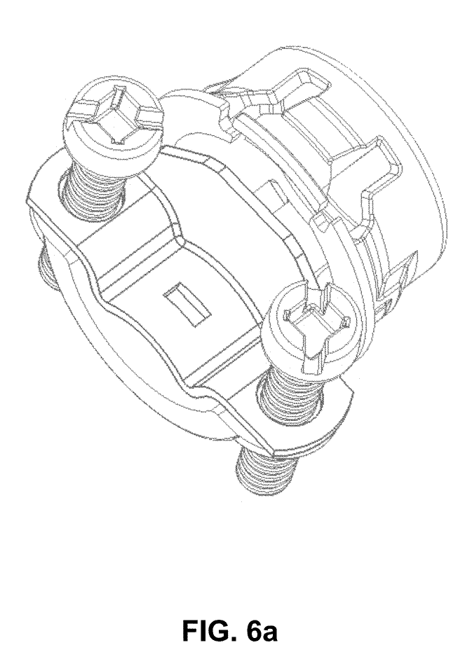

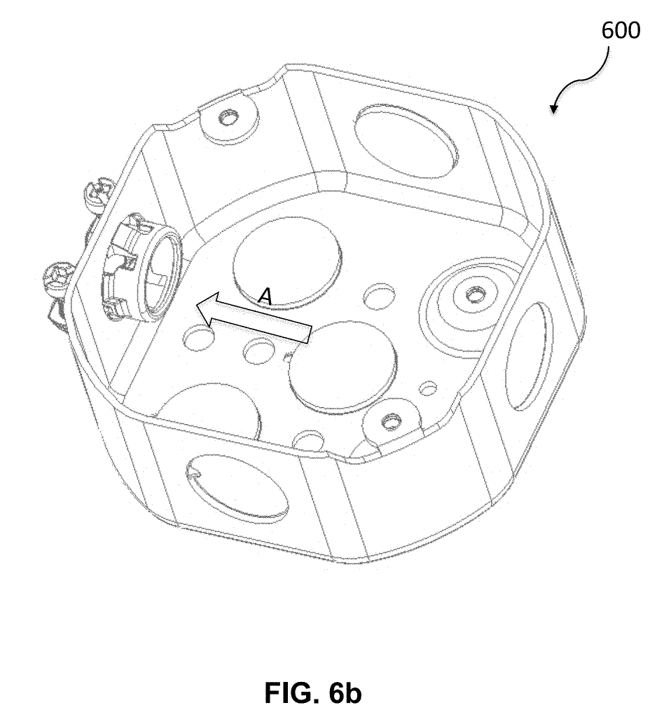

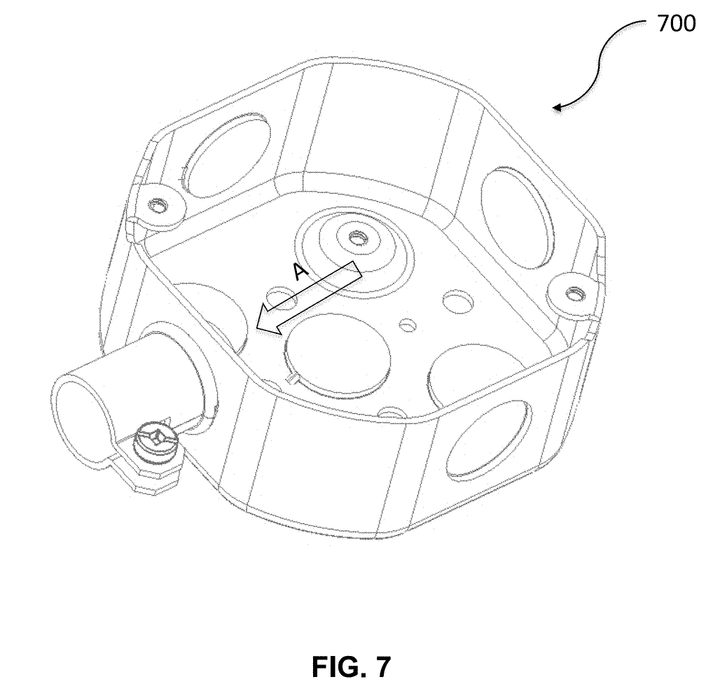

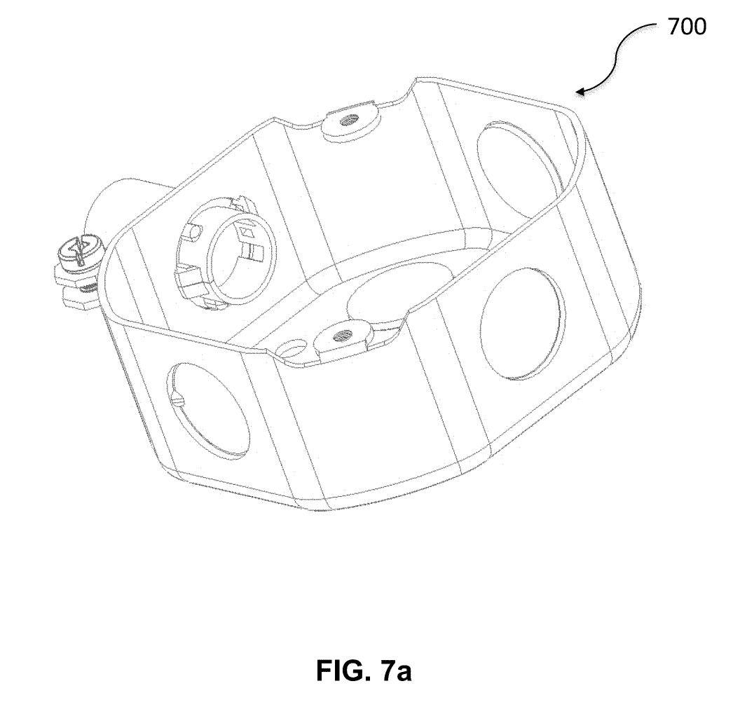

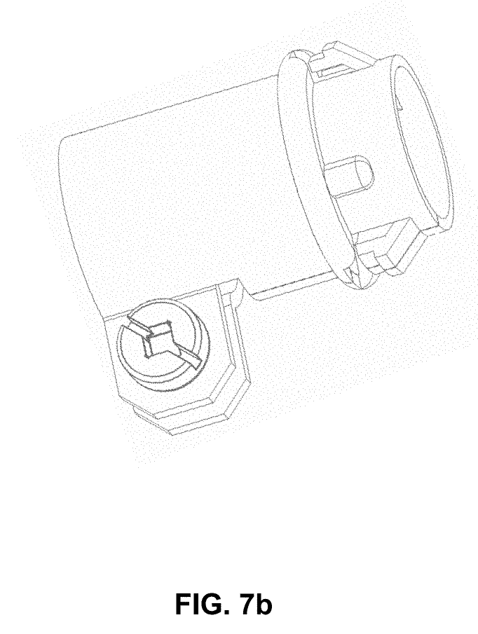

It is important to note that the snap fitting 300 can also be snapped into the box opening 510 from other side of the opening. More specifically, the snap fitting 300 can be snapped into the box opening 510 from inside of the junction box 500 along the direction A as shown in FIG. 5b. FIGS. 6, 6a and 6b, and 7, 7a 7b illustrate another two junction boxes 600 and 700 with a similar snapped-in mechanism of the snap fitting as discussed above.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A snap fitting comprising a trailing end adapted to be connected to flexible metallic conduit or metal clad cable, and a cylindrical leading end portion, wherein the leading end portion is formed with a plurality of locking fingers and tensioning fingers extending from each locking finger toward the trailing end; the locking fingers spread radially axially outwardly from near the outboard end of the leading end portion toward the trailing end; each locking finger has an exterior slanted surface that facilitates the assembly of the fitting to a junction box when the fitting is inserted into an opening of the junction box, which enables the locking fingers to flex radially inwardly during assembly of the fitting to the junction box; and the snap fitting is configured to be inserted into the junction box from both sides of the opening.

2. The snap fitting of claim 1, wherein each locking finger has a free end configured to engage an inside surface of the box wall when the fitting has been fully inserted.

3. The snap fitting of claim 1, wherein the snap fitting has a plurality of screw holes on the trailing end to align with screw holes on the junction box and the snap fitting is further secured when screws are inserted and tightened in the screw holes on the snap fitting and the junction box.
